(19) United States
(12) Patent Application Publication
(10) Pub. No.: US 2023/0091825 A1
(43) Pub. Date: Mar. 23, 2023

(54) CHECKOUT APPARATUS AND CHECKOUT METHOD

(71) Applicant: TOSHIBA TEC KABUSHIKI KAISHA, Tokyo (JP)

(72) Inventors: Yuji HAYASHI, Tagata Shizuoka (JP); Eisuke AOYAMA, Yao Osaka (JP)

(21) Appl. No.: 17/873,062

(22) Filed: Jul. 25, 2022

(30) Foreign Application Priority Data
Sep. 22, 2021 (JP) 2021-154099

(51) Int. Cl. G06Q 20/20; G06Q 30/06

(52) U.S. Cl. CPC G06Q 20/202; G06Q 20/208; G06Q 30/0607; G06Q 20/209

(57) ABSTRACT

A checkout apparatus in a point of sales (POS) system including a customer terminal and an attendant terminal, includes a network interface, a scanner, and a processor configured to, upon receipt of a checkout code from the customer terminal via the scanner, acquire data of one or more commodities that have been registered for purchase by the customer terminal, determine whether said one or more commodities include a particular type of commodity that needs to be checked by an attendant, and upon determining that said one or more commodities include the particular type of commodity, control the network interface to transmit a notification to the attendant terminal before executing checkout processing on the commodity.

### CROSS-REFERENCE TO RELATED APPLICATION

This application is based upon and claims the benefit of priority from Japanese Patent Application No. 2021-154099, filed Sep. 22, 2021, the entire contents of which are incorporated herein by reference.

### FIELD

Embodiments described herein relate generally to a checkout apparatus and a checkout method performed by a checkout apparatus.

### BACKGROUND

Currently, various types of drugs may be sold “over-the-counter” at retail stores such as supermarkets and drug stores. Such drugs may be classified into different categories under applicable laws depending on countries, e.g., a first-category medicinal product, a second-category medicinal product, and a third-category medicinal product under Japanese Pharmaceutical Affairs Law. For sale of medicinal products classified into a certain category, an explanation from a pharmacist or other interaction with a pharmacist or the like may be required before completion of a sale. For sale of some other medicinal products in other categories, a notification to a pharmacist or a registered seller may be required.

In general, a transaction processing system for retail sales of various commodities is already known. In such a transaction processing system, on a sales floor of a store where commodities are displayed, a customer may operate a portable terminal, such as a smartphone, to input data related to an item being purchased, and the customer then operates a dedicated checkout apparatus by himself/herself to pay for the item. By introducing such a transaction processing system into a retail store, there is no need for a store clerk or the customer to separately input the data related to the item being purchased using a checkout apparatus, and thus time required for checkout can be shortened.

However, in such a conventional transaction processing system, when the customer inputs data via the portable terminal to purchase a medicinal product that requires an explanation or the like by a pharmacist or a registered seller , the checkout apparatus will show an error in the transaction processing because the required explanation or the like has not been given from the pharmacist or the registered seller, and thus the medicinal product cannot be sold using the conventional system without additional intervention and delay. In such a case, it may be necessary to re-input the data related to the purchased items, which is troublesome for the customer.

### BRIEF DESCRIPTION OF THE DRAWINGS

FIG. 1 is a schematic block diagram of a point of sales (POS) system.

FIG. 2 is a sequence diagram illustrating main functions of a shopping supporting terminal and a virtual POS server.

FIG. 3 is a hardware block diagram of a checkout machine according to a first embodiment.

FIG. 4 depicts a data structure of an attendant database including attendant data records.

FIG. 5 depicts a data structure of a management database including management data records.

FIGS. 6-8 are flowcharts of information processing executed by a checkout machine.

FIG. 9 is a schematic diagram illustrating an example of a call screen.

FIG. 10 is a schematic diagram illustrating an example of a first notification screen.

FIG. 11 is a hardware block diagram of a checkout machine according to a second embodiment.

FIGS. 12 and 13 are flowcharts of information processing executed by a checkout machine.

FIG. 14 is a schematic diagram illustrating an example of a second notification screen.

### DETAILED DESCRIPTION

In general, according to one embodiment, a checkout apparatus and a checkout method that are capable of registering a purchased commodity, which needs to be checked by an attendant, without a troublesome feeling are provided.

In one embodiment, a checkout apparatus in a POS system including a customer terminal and an attendant terminal is provided. The checkout apparatus includes a network interface, a scanner, and a processor. The processor is configured to: upon receipt of a checkout code from the customer terminal via the scanner, acquire data of one or more commodities that have been registered for purchase by the customer terminal, determine whether said one or more commodities include a particular type of commodity that needs to be checked by an attendant, and upon determining that said one or more commodities include the particular type of commodity, control the network interface to transmit a notification to the attendant terminal before executing checkout processing on the commodity.

Hereinafter, certain example embodiments will be described with reference to drawings.

One embodiment provides a POS system S in which sales transaction processing is performed. In the POS system S, a customer operates a portable terminal on the sales floor to input (register) data related to a commodity to be purchased, and the customer then subsequently operates a dedicated checkout apparatus to execute payment for the commodity already registered using the portable terminal.

### First Embodiment

### Description of Configuration of POS System S

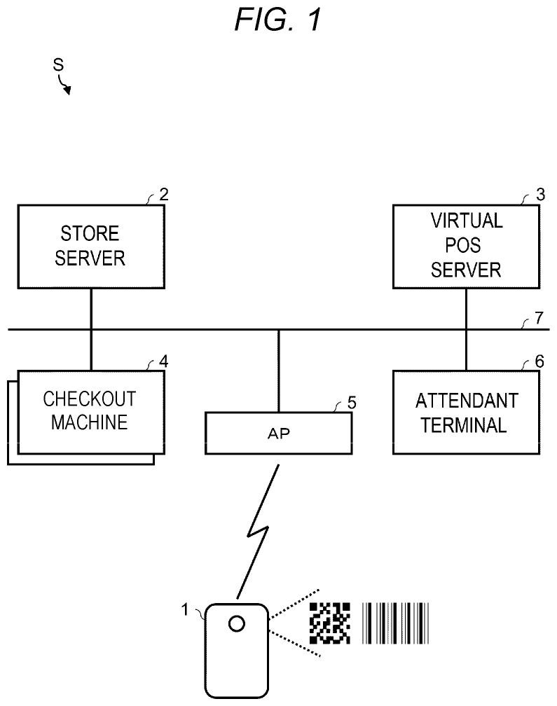

FIG. 1 is a schematic block diagram of the POS system S. The POS system S includes a shopping supporting terminal 1, a store server 2, a virtual point of sales (POS) server 3, checkout machines 4, an access point 5, and an attendant terminal 6. The store server 2, the virtual POS server 3, the checkout machines 4, the access point 5, and the attendant terminal 6 are interconnected by a communication network 7. For example, the communication network 7 is a wired or wireless local area network (LAN).

The shopping supporting terminal 1 is a portable terminal used by a customer to input data related to a “purchased commodity” (the commodity/item in this context is referred to as “purchased” as soon as the customer displays an intent to ultimately pay for the item/commodity by registering the item/commodity with the shopping support terminal 1). The shopping supporting terminal 1 includes an imaging device for reading a code symbol, such as a two-dimensional code or a barcode, in addition to an input device, a display device, and a wireless unit. For example, a commercially available smartphone, a tablet terminal, or the like equipped with a digital camera can be used as the shopping supporting terminal 1.

The store server 2 performs various functions for supporting general store operations. The store server 2 manages various databases including a commodity database (also referred to as a commodity master table or list in some instances). The commodity database includes commodity records in which data of each commodity sold in a store is described. Commodity data such as a commodity code, a major classification code, a minor classification code, a commodity name, and a price are described in the commodity record.

The commodity code is a unique identification code set for each commodity in order to individually identify the commodity. Usually, a barcode indicating a commodity code is attached to the commodity.

The major classification code is a unique identification code set for various possible commodity classifications in order to categorize commodities based on certain shared attributes of each commodity. For example, the possible commodity classifications include groceries, daily necessities, medicinal products, clothing, and the like. In the present example, medicinal products are further classified into first-category medicinal products, second-category medicinal products, and third-category medicinal products. The first-category medicinal products can only be sold by a pharmacist. For sale of the first-category medicinal products, an interaction with a pharmacist is required. In other words, a pharmacist is the only store employee (attendant) who is allowed to authorize a sale of the first-category medicinal products. The second-category medicinal products and the third-category medicinal products can be sold either by a pharmacist or a pre-registered seller. For sale of the second-category medicinal products and the third-category medicinal products, an explanation by a pharmacist or a registered seller may be required before purchase can be completed. In other words, a pharmacist or a registered seller (e.g., a trained pharmacist technician or assistant) is allowed to authorize sales of the second-category medicinal products and the third-category medicinal products. The first-category medicinal products, the second-category medicinal products, and the third-category medicinal products are hereinafter collectively referred to as “checking target commodities” since some store employee/attendant must first check or confirm that certain requirements related to the sale have been satisfied before the sale is completed. A checking target commodity is one that need to be monitored or authorized by an attendant of some type at the time of sale.

In order to distinguish the checking target commodities from other medicinal products, the minor classification codes can be used. A different minor classification code can be set for each of the first-category medicinal product, the second-category medicinal product, and the third-category medicinal product, even though each may be checking target commodities.

The virtual POS server 3 cooperates with the shopping supporting terminal 1 to provide the functions of a well-known POS terminal. For example, the virtual POS server 3 has the following three functions. The first function is a function of registering, in a transaction file, commodity sales data of a commodity identified according to the commodity code input via the shopping supporting terminal 1. The commodity sales data and the transaction file will be described later. The second function is a function of causing the display device of the shopping supporting terminal 1 to display a registration screen generated based on the commodity sales data registered in the transaction file. The third function is a function of causing the display device of the shopping supporting terminal 1 to display a checkout barcode in response to a checkout instruction from the shopping supporting terminal 1. The checkout barcode will be described later.

The checkout machine 4 is a dedicated checkout apparatus that enables a customer who inputs the data related to the purchased commodity using the shopping supporting terminal 1 to make payment of the purchased commodity. A plurality of checkout machines 4 are connected to the communication network 7. A payment method is not particularly limited. Well-known payment methods such as cash payment, credit card payment, electronic money payment, point payment, and code payment (also referred to as mobile payment or smartphone payment) can be used to complete sales transactions.

The access point 5 is a communication device provided in the store as a relay device when components (e.g., the store server 2, the virtual POS server 3, or the like) of the POS system S executes data communication with the shopping supporting terminal 1 via the wireless LAN. The wireless LAN conforms to, for example, a Wi-Fi standard. Although FIG. 1 illustrates only one access point 5 in the POS system S, the number of the access points 5 is not limited. A plurality of access points 5 may be connected to the communication network 7 depending on a scale of the store or the like.

The attendant terminal 6 is a terminal for an attendant to monitor states of the shopping supporting terminal 1 and the checkout machines 4. Examples of the attendant include a store clerk, a pharmacist, a registered seller, and the like. In an embodiment, a store clerk is not qualified as a pharmacist or a registered seller.

The configuration of the POS system S is not limited to the configuration illustrated in FIG. 1. For example, the number of servers may be reduced by integrating the functions of the store server 2 and the virtual POS server 3 into one server. In addition to the checkout machine 4, a well-known POS terminal that allows an attendant to execute a registration operation and a checkout operation of the purchased commodity, or a semi-self-service registration and checkout machines separated from each other may be connected to the communication network 7. In the semi-self-service registration and checkout machines, an attendant executes a registration operation of the purchased commodity using the registration machine, and a customer executes a checkout operation using the checkout machine.

Description of Functions of Shopping Supporting Terminal 1 and Virtual POS Server 3

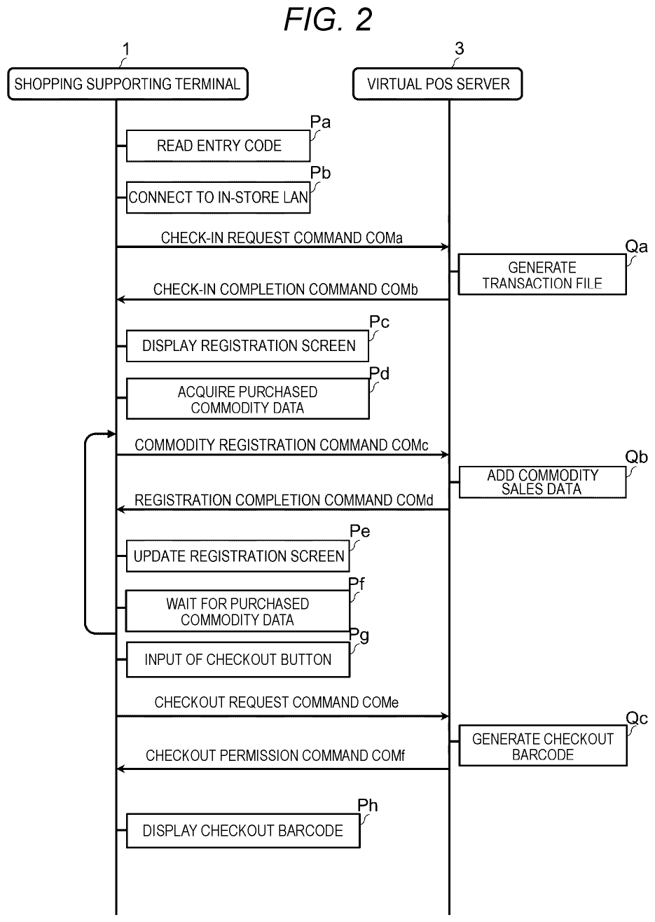

Next, main functions of the shopping supporting terminal 1 and the virtual POS server 3 will be described with reference to a sequence diagram in FIG. 2.

First, for example, a customer who wants to use a smartphone as the shopping supporting terminal 1 installs, in the smartphone, a shopping supporting application program for a store in which the POS system S is constructed, that is, a so-called shopping application. Then, the customer can use the smartphone as the shopping supporting terminal 1 by executing user registration.

The customer carrying the shopping supporting terminal 1 activates a shopping application before entering a store. Then, as indicated by a function Pa, a camera of the shopping supporting terminal 1 is activated to read an entry code. The entry code is obtained by encoding setting information related to the store in a predetermined two-dimensional code system, and is prepared, for example, at an entrance of the store. The setting information includes, for example, parameters necessary for the shopping supporting terminal 1 to communicate with the access point 5 using the wireless LAN, or information related to an operation restriction of the shopping supporting terminal 1. The customer causes the camera of the shopping supporting terminal 1 to read the entry code.

When the entry code is read by the shopping supporting terminal 1, the shopping supporting terminal 1 is connected to the access point 5 using the wireless LAN, as indicated by a function Pb. Then, if the shopping supporting terminal 1 is connected to the access point 5, the shopping supporting terminal 1 transmits a check-in request command COMa to the virtual POS server 3. The check-in request command COMa is transmitted from the access point 5 to the virtual POS server 3 via the communication network 7. The check-in request command COMa includes terminal identification information of the shopping supporting terminal 1. The terminal identification information is unique information different from that of other shopping supporting terminals 1 used by other customers. For example, a program ID of the shopping application installed in the shopping supporting terminal 1 is used as the terminal identification information.

The virtual POS server 3 that has received the check-in request command COMa generates a transaction file as indicated by a function Qa. The transaction file is a data file for storing commodity sales data of a commodity identified by a commodity code input via the shopping supporting terminal 1. The transaction file is generated for each shopping supporting terminal 1. Each transaction file is associated with the terminal identification information of the shopping supporting terminal 1.

The virtual POS server 3 that has generated the transaction file transmits a check-in completion command COMb to the shopping supporting terminal 1 which is a transmission source of the check-in request command COMa. The check-in completion command COMb is transmitted from the access point 5 to the shopping supporting terminal 1 via the communication network 7.

The shopping supporting terminal 1 that has received the check-in completion command COMb controls the display device to display a registration screen as illustrated by a function Pc. For example, the registration screen displays a commodity name, a price, and the like of a commodity identified according to a commodity code input via the shopping supporting terminal 1. A commodity registration button is displayed on the registration screen.

The customer sets the shopping supporting terminal 1 on a shopping cart or carries the shopping supporting terminal 1 and goes around a sales floor where various commodities are displayed. Then, when a purchased commodity is found, the customer operates the commodity registration button. When the commodity registration button is operated, the shopping supporting terminal 1 acquires data of the purchased commodity as indicated by a function Pd. For example, the shopping supporting terminal 1 is in a barcode reading standby state. The customer causes the camera to read the barcode attached to the purchased commodity. When the barcode of the commodity is read by the camera, the shopping supporting terminal 1 acquires the commodity code indicated by the barcode as the data of the purchased commodity.

A no-barcode button is also displayed on the registration screen. If no barcode is attached to a purchased commodity, the customer operates the no-barcode button. When the no-barcode button is input, a list of no-barcode commodities is displayed on the display device. The customer selects the purchased commodity from the list. When the purchased commodity is selected, the shopping supporting terminal 1 acquires the commodity code of the selected commodity as the data of the purchased commodity.

When the data of the purchased commodity is acquired, the shopping supporting terminal 1 transmits a commodity registration command COMc to the virtual POS server 3. The commodity registration command COMc is transmitted from the access point 5 to the virtual POS server 3 via the communication network 7. The commodity registration command COMc includes the terminal identification information of the shopping supporting terminal 1 and the data of the purchased commodity.

The virtual POS server 3 that has received the commodity registration command COMc adds, as indicated by a function Qb, commodity sales data to the transaction file associated with the terminal identification information of the shopping supporting terminal 1 which is a transmission source of the commodity registration command COMc. The commodity sales data includes the commodity code, the major classification code, the minor classification code, the commodity name, the unit price, the sales quantity, the sales amount, and the like of the purchased commodity in an order of a series of numbers. The sales amount is an amount obtained by multiplying the unit price by the sales quantity. The commodity sales data of the checking target commodity includes the major classification code of the medicinal product and the minor classification code of the checking target commodity. For example, the commodity sales data of the medicinal product other than the checking target commodity includes the major classification code of the medicinal product and the minor classification code of the other medicinal product.

The virtual POS server 3 that has added the commodity sales data to the transaction file transmits a registration completion command COMd to the shopping supporting terminal 1 which is the transmission source of the commodity registration command COMc. The registration completion command COMd is transmitted from the access point 5 to the shopping supporting terminal 1 via the communication network 7.

The shopping supporting terminal 1 that has received the registration completion command COMd updates the registration screen as indicated by a function Pe. That is, the shopping supporting terminal 1 updates the registration screen such that the commodity name, the price, and the like of the commodity sales data added to the transaction file are displayed. On the updated registration screen, a checkout button is also displayed together with the commodity registration button and the like. The shopping supporting terminal 1 that has updated the registration screen waits for an input of the data of the purchased commodity as indicated by a function Pf or an input of the checkout button as indicated by a function Pg.

When the customer finds a next purchased commodity, the customer operates the commodity registration button. When the commodity registration button is operated, the shopping supporting terminal 1 acquires the data of the purchased commodity. Then, the shopping supporting terminal 1 transmits the commodity registration command COMc to the virtual POS server 3. Subsequent functions of the shopping supporting terminal 1 and the virtual POS server 3 are the same as described above.

The customer who completed shopping in the sales floor operates the checkout button. When the checkout button is operated, the shopping supporting terminal 1 transmits a checkout request command COMe to the virtual POS server 3. The checkout request command COMe is transmitted from the access point 5 to the virtual POS server 3 via the communication network 7. The checkout request command COMe includes the terminal identification information of the shopping supporting terminal 1.

Thereafter, the virtual POS server 3 generates a unique checkout barcode as indicated by a function Qc. For example, the virtual POS server 3 generates a checkout barcode by encoding, by a predetermined barcode system, the terminal identification information of the shopping supporting terminal 1 which is a transmission source of the checkout request command COMe. The virtual POS server 3 that has generated the checkout barcode transmits a checkout permission command COMf to the shopping supporting terminal 1 which is the transmission source of the checkout request command COMe. The checkout permission command COMf is transmitted from the access point 5 to the shopping supporting terminal 1 via the communication network 7. The checkout permission command COMf includes data of the checkout barcode.

The shopping supporting terminal 1 that has received the checkout permission command COMf causes the display device to display an image of the checkout barcode, as indicated by a function Ph. The checkout barcode is used for checkout using the checkout machine 4. Next, the checkout machine 4 will be described.

Description of Configuration of Checkout Machine 4

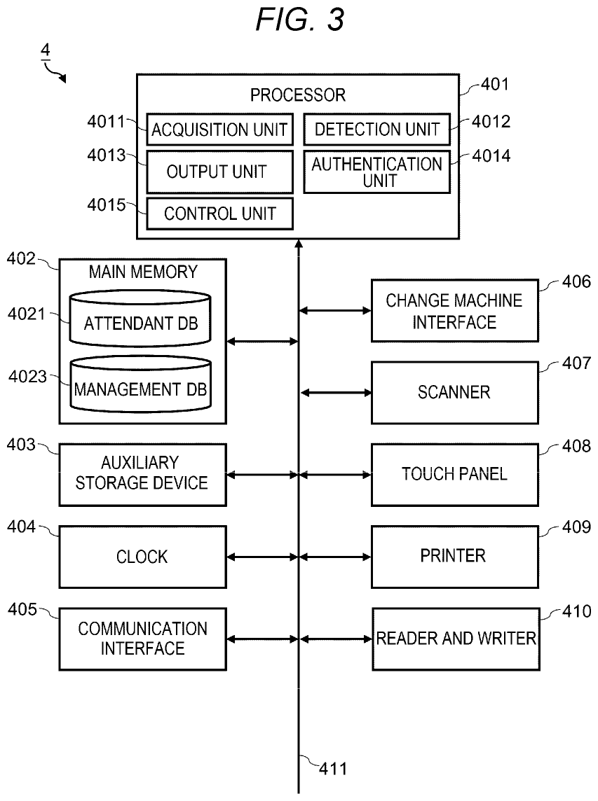

FIG. 3 is a hardware block diagram of the checkout machine 4. The checkout machine 4 includes a processor 401, a main memory 402, an auxiliary storage device 403, a clock 404, a communication interface 405, a change machine interface 406, a scanner 407, a touch panel 408, a printer 409, a reader and writer 410, a system transmission path 411, and the like. The system transmission path 411 includes an address bus, a data bus, a control signal line, and the like. The system transmission path 411 connects the processor 401 and the other units directly or via a signal input and output circuit, and transmits data signals exchanged between the processor 401 and the other units.

The checkout machine 4 is a computer or a dedicated device in which the processor 401, the main memory 402, the auxiliary storage device 403, the clock 404, and the communication interface 405 are connected via the system transmission path 411. Further, the change machine interface 406, the scanner 407, the touch panel 408, the printer 409, and the reader and writer 410 are connected to the computer or the dedicated device via the system transmission path 411.

The processor 401 controls each unit to perform various functions as the checkout machine 4 according to an operating system or an application program. The processor 401 is, for example, a central processing unit (CPU).

The main memory 402 includes a nonvolatile memory region and a volatile memory region. The nonvolatile memory region of the main memory 402 stores the operating system or the application program. The data necessary for the processor 401 to execute processing for controlling each unit may be stored in the nonvolatile or volatile memory region. The volatile memory region is used as a work area where data is appropriately rewritten by the processor 401. The nonvolatile memory region is, for example, a read only memory (ROM). The volatile memory region is, for example, a random access memory (RAM). The main memory 402 stores information about a target commodity detected by a detection unit, which will be described later.

The auxiliary storage device 403 is, for example, an electric erasable programmable read-only memory (EEPROM®), a hard disc drive (HDD), or a solid state drive (SSD). The auxiliary storage device 403 stores data used when the processor 401 executes various types of processing, data generated by the processor 401, and the like. The auxiliary storage device 403 may store the above-described application program.

The clock 404 tracks date and time. The processor 401 acquires the date and time tracked by the clock 404 as current date and time.

The communication interface 405 is an interface circuit that executes the data communication with the store server 2, the virtual POS server 3, the checkout machine 4, the access point 5, the attendant terminal 6, and the like that are connected via the communication network 7.

The change machine interface 406 is an interface circuit connected to an automatic change machine (not illustrated). The change machine interface 406 receives, from the automatic change machine, amount data of money inserted into the automatic change machine. The change machine interface 406 outputs change data to the automatic change machine. The automatic change machine to which the change data has been input automatically dispenses change.

The scanner 407 is a reading device that reads a code symbol such as a barcode and a two-dimensional code. The scanner 407 may be a type of reading device that reads a code symbol by performing scanning with a laser beam or a type of reading device that reads a code symbol from an image captured by an imaging device.

The touch panel 408 is a device including both an input device and a display device. The touch panel 408 displays information for a customer who is an operator of the checkout machine 4, and receives an operation input inputted by the customer.

The printer 409 dispenses a receipt by printing various character strings, images, or the like on a piece of receipt paper. As the printer 409 of this type, for example, a thermal printer, a dot impact printer, or the like can be used.

The reader and writer 410 has a function of reading data recorded on a medium such as a card or a smartphone, and a function of writing data to such a medium. The card may include a point card called an in-house point card, a common point card, or the like, in addition to a payment card such as a credit card, a debit card, an electronic money card, or a prepaid card. The reader and writer 410 may be any device of a magnetic type, a contact type, or a non-contact type, or may include a plurality of types of devices.

The checkout machine 4 having such a configuration stores an attendant database 4021 and a management database 4023 in a part of the volatile memory region of the main memory 402.

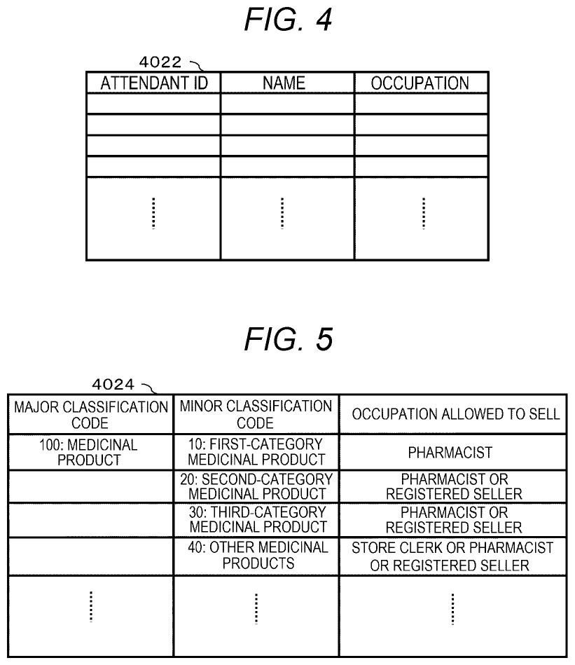

FIG. 4 depicts a data structure of the attendant database 4021 including attendant data records 4022. As illustrated in FIG. 4, each attendant data record 4022 includes an attendant ID, a name, an occupation, and the like. Examples of the occupation include a store clerk, a pharmacist, a registered seller, and the like. The attendant data record 4022 is not limited to data of the above items.

FIG. 5 depicts a data structure of the management database 4023 including management data records 4024. As illustrated in FIG. 5, each management data record 4024 includes a major classification code, a minor classification code, an occupation allowed to sell, and the like. The occupation allowed to sell is, for example, a pharmacist in the case of a first-category medicinal product. The occupation allowed to sell is, for example, a pharmacist or a registered seller in the case of a second-category medicinal product and a third-category medicinal product. The occupation allowed to sell is, for example, a store clerk, a pharmacist, or a registered seller in the case of the other medicinal products. The management data record 4024 is not limited to data of the above items.

The processor 401 of the checkout machine 4 performs functions of an acquisition unit 4011, a detection unit 4012, an output unit 4013, an authentication unit 4014, and a control unit 4015.

The acquisition unit 4011 functions to acquire registered data related to sale of a purchased commodity using the shopping supporting terminal 1 operated by a customer.

The detection unit 4012 functions to detect, based on the data related to the sale of the purchased commodity acquired by the acquisition unit 4011, a target commodity that needs to be checked by an attendant.

The output unit 4013 has three functions. The first function is a function of outputting, when a target commodity is detected by the detection unit 4012, a notification that the target commodity was detected by the detection unit 4012, to the attendant terminal 6 used by an attendant. The second function is a function of outputting, when the target commodity is detected by the detection unit 4012, a notification that the target commodity was detected by the detection unit 4012, to the display unit, that is, the touch panel 408. The third function is a function of outputting, when data of the target commodity is stored in the main memory 402, a notification that the data of the target commodity is stored in the main memory 402, to the attendant terminal 6.

The authentication unit 4014 functions to authenticate whether the notified attendant is allowed to check the target commodity when the target commodity is detected by the detection unit 4012.

The control unit 4015 functions to execute control to execute registration processing of the target commodity when the authentication unit 4014 authenticates that the attendant is allowed to check the target commodity.

The functions of the acquisition unit 4011, the detection unit 4012, the output unit 4013, the authentication unit 4014, and the control unit 4015 are all executed by the processor 401 according to a checkout program. The checkout program is a type of an application program stored in the main memory 402 or the auxiliary storage device 403. A method for installing the checkout program in the main memory 402 or the auxiliary storage device 403 is not particularly limited. The checkout program can be installed in the main memory 402 or the auxiliary storage device 403 from a non-transitory computer readable recording medium or downloaded via the communication network 7. A form of the recording medium is not limited as long as the recording medium can store programs, such as a CD-ROM, a memory card, or the like.

Description of Operation of Checkout Machine 4

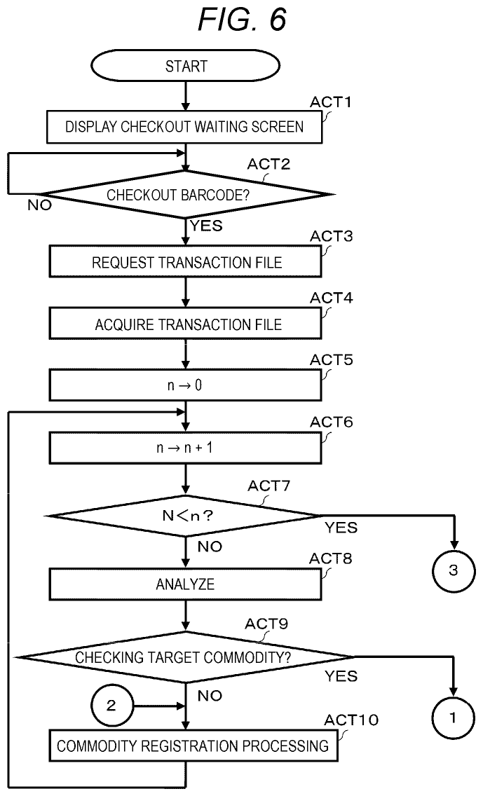

FIGS. 6 to 8 are flow charts of information processing executed by the processor 401 according to the checkout program. Hereinafter, main operations of the checkout machine 4 will be described with reference to the drawings. The procedure described below is an example. The procedure or each step may be changed appropriately as long as the same effects can be achieved.

In ACT 1 in FIG. 6, the processor 401 controls the touch panel 408 to display a checkout waiting screen. The checkout waiting screen is, for example, a screen for displaying a guidance for guiding a customer who has registered a purchased commodity using the shopping supporting terminal 1 to cause the scanner 407 to read the checkout barcode displayed on the display device of the shopping supporting terminal 1. In ACT 2, the processor 401 waits for the checkout barcode to be read by the scanner 407.

The customer who confirmed that the checkout barcode is displayed on the display device of the shopping supporting terminal 1 after completing shopping at the sales floor and operating the checkout button, moves to an installation place of the checkout machine 4. Then, the customer holds the checkout barcode over the scanner 407 of the checkout machine 4 on which the checkout waiting screen is displayed. When the checkout barcode is held over the scanner 407, the checkout barcode is read by the scanner 407.

When the checkout barcode is read by the scanner 407, the processor 401 determines YES in ACT 2, and proceeds to ACT 3. In ACT 3, the processor 401 requests the virtual POS server 3 to transmit the corresponding transaction file. As described above, the checkout barcode is obtained by encoding the terminal identification information of the shopping supporting terminal 1. The transaction file stored in the virtual POS server 3 is associated with the terminal identification information of the shopping support terminal 1. Therefore, the processor 401 requests the transaction file associated with the terminal identification information obtained from the checkout barcode. The virtual POS server 3 that has received the request transmits the transaction file associated with the terminal identification information to the checkout machine 4.

In ACT 4, the processor 401 acquires, by the function of the acquisition unit 4011, the transaction file transmitted from the virtual POS server 3.

In ACT 5, the processor 401 initializes a number counter n to “0”. In ACT 6, the processor 401 counts up the number counter n by “1”. In ACT 7, the processor 401 checks whether the number counter n exceeds a maximum value N of the series of numbers in the commodity sales data registered in the transaction file.

If the number counter n is equal to or less than the maximum value N, the processor 401 determines NO in ACT 7 and proceeds to ACT 8.

In ACT 8, the processor 401 analyzes the commodity sales data registered in the transaction file for each piece of the commodity sales data in the order of the series of numbers. In ACT 9, the processor 401 checks, based on the management data record 4024 stored in the management database 4023, whether the minor classification code included in the commodity sales data indicates a checking target commodity.

If the minor classification code does not indicate a checking target commodity, the processor 401 determines NO in ACT 9 and proceeds to ACT 10. In ACT 10, the processor 401 executes commodity registration processing of the n-th purchased commodity. Specifically, the processor 401 registers and processes sales data of the n-th purchased commodity in a sales totalization memory based on the commodity sales data analyzed by the processing in ACT 8. Through the registration processing, a total amount of the sales transaction is calculated. The sales totalization memory is a part of the volatile memory region of the main memory 402. Then, the processor 401 returns to ACT 6. Then, the processor 401 executes the processing of ACT 6 to ACT 10 in the same manner as described above.

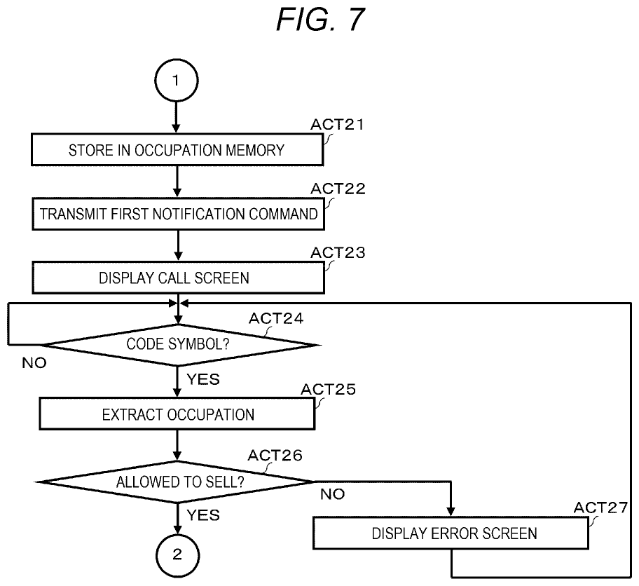

If the minor classification code indicates a checking target commodity, the processor 401 determines YES in ACT 9, and proceeds to ACT 21 in FIG. 7. That is, the processor 401 detects, by the function of the detection unit 4012, a checking target commodity based on the commodity sales data.

In ACT 21, based on the management data record 4024 stored in the management database 4023, the processor 401 extracts the occupation allowed to sell corresponding to the minor classification code, and stores the occupation allowed to sell in an occupation memory. The occupation memory is a part of the volatile memory region of the main memory 402.

In ACT 22, by the function of the output unit 4013, the processor 401 issues a first notification command, and controls the communication interface 405 to transmit the first notification command to the attendant terminal 6. By this control, the first notification command is transmitted from the communication interface 405 to the attendant terminal 6 via the communication network 7. The first notification command includes a checkout machine ID, the occupation allowed to sell, and data of the commodity name of the checking target commodity. The checkout machine ID is checkout machine identification information set for each checkout machine 4 in order to individually identify each checkout machine 4.

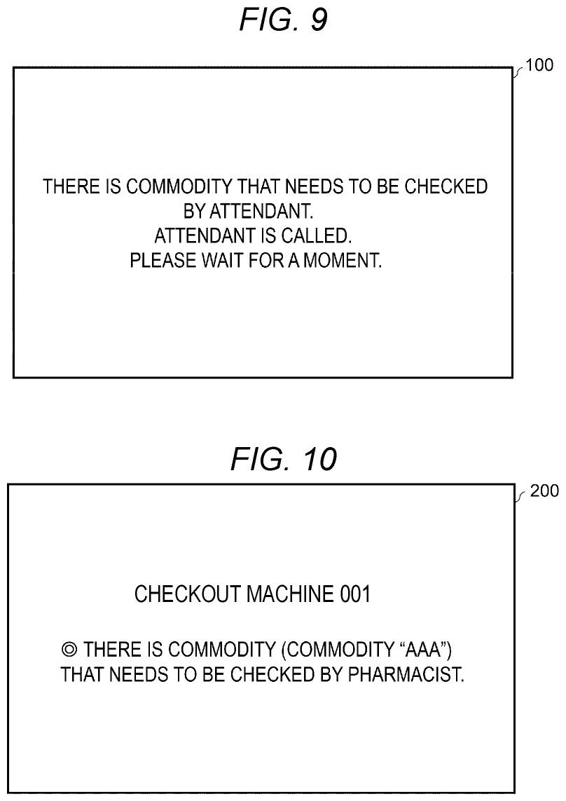

In ACT 23, the processor 401 causes, by the function of the output unit 4013, the touch panel 408 to display a call screen 100 (see FIG. 9).

FIG. 9 is a schematic diagram illustrating an example of the call screen 100. As illustrated in FIG. 9, the call screen 100 includes a message for notifying the customer that there is an item (e.g., a checking target commodity) that needs to be checked by an attendant and that the attendant has been called. The text displayed in FIG. 9 is an example.

The attendant terminal 6 that has received the first notification command causes the touch panel to display a first notification screen 200 (see FIG. 10).

FIG. 10 is a schematic diagram illustrating an example of the first notification screen 200. As illustrated in FIG. 10, the first notification screen 200 includes a message for notifying the attendant that there is a commodity that needs to be checked by the attendant on the checkout machine 4 identified according to the checkout machine ID. FIG. 10 illustrates a case in which there is a commodity “AAA” that needs to be checked by a pharmacist on the checkout machine 4 having the checkout machine ID of “001”. The text displayed in FIG. 10 is an example.

The attendant who checked the first notification screen 200 rushes to the checkout machine 4 which is a notification target. In order to cause the checkout machine 4 to operate in an attendant mode, the attendant causes the scanner 407 to read a code symbol such as a barcode or a two-dimensional code in which the attendant ID is stored. The code symbol is printed on, for example, an ID card possessed by each attendant. That is, in ACT 24 in FIG. 7, the processor 401 waits for a code symbol in which an attendant ID is stored to be read by the scanner 407.

If a code symbol in which an attendant ID is stored is read by the scanner 407, the processor 401 determines YES in ACT 24 and proceeds to ACT 25.

In ACT 25, the processor 401 extracts the occupation corresponding to the attendant ID, based on the attendant data record 4022 stored in the attendant database 4021.

In ACT 26, the processor 401 checks, by the function of the authentication unit 4014, whether the occupation extracted in the processing of ACT 25 is included in the occupation allowed to sell stored in the occupation memory.

If the occupation extracted in the processing of ACT 25 is included in the occupation allowed to sell stored in the occupation memory, the processor 401 determines YES in ACT 26, and proceeds to ACT 10 in FIG. 6. That is, the processor 401 determines that the checking target commodity was checked by a qualified attendant and executes the commodity registration processing of the checking target commodity by the function of the control unit 4015. Then, the processor 401 executes the processing of ACT 6 to ACT 10 in the same manner as described above.

If the occupation extracted in the processing of ACT 25 is not included in the occupation allowed to sell stored in the occupation memory, the processor 401 determines NO in ACT 26, and proceeds to ACT 27.

In ACT 27, the processor 401 causes the touch panel 408 to display an error screen. The error screen is, for example, a screen for notifying the attendant that the attendant ID is not allowed to sell the checking target commodity and that a barcode storing a qualified attendant ID needs to be read by the scanner 407. The error screen may further include, for example, a notification of an occupation allowed to sell. Then, the processor 401 returns to ACT 24. That is, the processor 401 waits for a code symbol in which an attendant ID is stored to be read by the scanner 407.

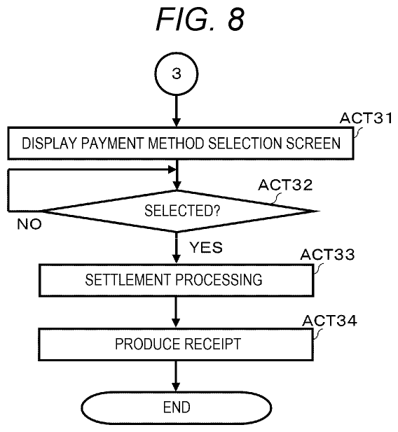

Return to the description of FIG. 6. If the number counter n exceeds the maximum value N, that is, if the analysis of the commodity sales data for all the series of numbers is completed, the processor 401 determines YES in ACT 7 and proceeds to ACT 31 in FIG. 8.

In ACT 31, the processor 401 controls the touch panel 408 to display a payment method selection screen. The payment method selection screen is, for example, a screen on which images of payment method selection buttons such as a cash button, a credit button, and an electronic money button are provided. If the cash button is touched, cash is selected as a payment method. If the credit button is touched, the credit card is selected as the payment method. If the electronic money button is touched, the electronic money is selected as the payment method. The payment method is not limited to these three types of cash, credit card, and electronic money. Any two types of these payment methods may be used, or another payment method may be selectable. Further, only one type of payment method may be used. In such a case, instead of the payment method selection buttons, for example, a checkout start button for starting checkout may be displayed on the payment method selection screen.

In ACT 32, the processor 401 waits for a payment method to be selected. Then, when one of the payment methods is selected via the payment method selection screen, the processor 401 determines YES in ACT 32 and proceeds to ACT 33.

In ACT 33, the processor 401 executes checkout processing. For example, if the cash is selected as the payment method, the processor 401 subtracts the total amount from the amount inserted into the automatic change machine, calculates the change, and pays out the change from the automatic change machine. For example, if the credit card is selected as the payment method, the processor 401 authenticates the credit card read by the reader and writer 410, and determines the total amount as a credit payment amount on condition that the credit card was approved. For example, if the electronic money is selected as the payment method, the processor 401 subtracts the total amount from a balance of an electronic money medium read by the reader and writer 410.

In ACT 34, the processor 401 controls the printer 409 to dispense a receipt. Transaction details data such as a commodity name, a price, a quantity, a purchase amount, a total quantity, a total amount, and a payment amount of the purchased commodity are printed on the receipt. Subsequently, the processor 401 ends the procedure illustrated in FIGS. 6 to 8.

As described in detail above, when a checkout barcode is read by the scanner 407, the processor 401 of the checkout machine 4 acquires the transaction file associated with the checkout barcode from the virtual POS server 3. Based on the management data record 4024 stored in the management database 4023, the processor 401 checks for each piece of the commodity sales data whether the minor classification code included in the commodity sales data registered in the transaction file indicates a checking target commodity. If the minor classification code indicates a checking target commodity, the processor 401 extracts the occupation allowed to sell corresponding to the minor classification code based on the management data record 4024 and stores the occupation allowed to sell in the occupation memory. Then, the processor 401 issues a first notification command to the attendant terminal 6. Accordingly, the first notification screen 200 is displayed on the touch panel of the attendant terminal 6. Therefore, the attendant can easily know that there is a commodity that needs to be checked by a store clerk, a pharmacist, or a registered seller at the checkout machine 4 corresponding to the notification.

If the minor classification code indicates a checking target commodity, the processor 401 causes the touch panel 408 to display the call screen 100. Therefore, the customer can know that there is a checking target commodity among the purchased commodities.

When the attendant causes the scanner 407 to read the code symbol in which the attendant ID is stored, the processor 401 extracts the occupation corresponding to the attendant ID, based on the attendant data record 4022 stored in the attendant database 4021. If the occupation corresponding to the attendant ID is included in the occupation allowed to sell stored in the occupation memory, the processor 401 determines that the checking was executed by the qualified attendant, and executes the commodity registration processing of the checking target commodity. Therefore, even if there is a checking target commodity, the checking target commodity can be registered merely by causing the scanner 407 to read the code symbol in which the qualified attendant ID is stored. Since the customer or the attendant does not need to re-input the data related to the purchased commodity, the checking target commodity can be registered without a troublesome feeling.

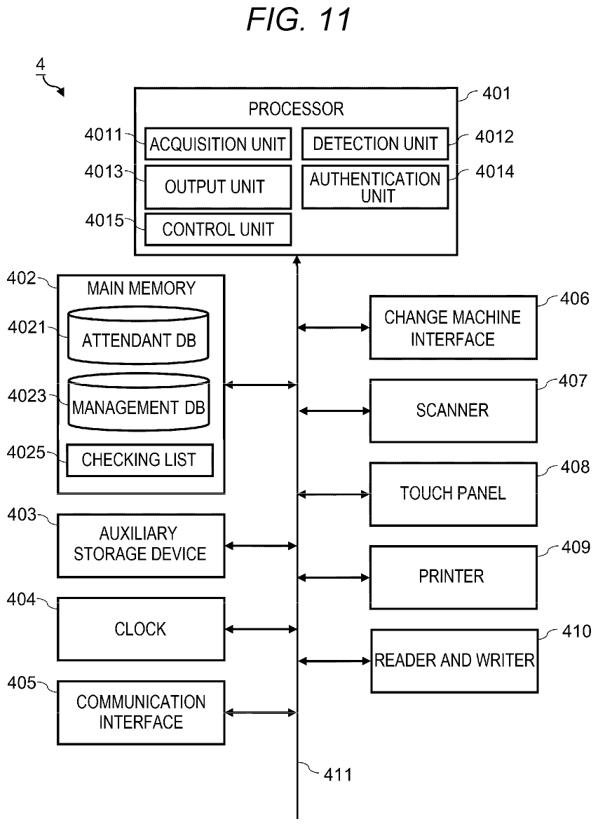

Second Embodiment Next, a second embodiment will be described with reference to FIGS. 11 to 14.

The second embodiment is different from the first embodiment in that when the processor 401 detects a checking target commodity based on commodity sales data by a function of the detection unit 4012, the processor 401 describes data related to the checking target commodity in a checking list 4025. The second embodiment is also different from the first embodiment in that the attendant terminal 6 is notified of a second notification command when analysis of the commodity sales data for all the purchased items is completed and the data indicating a checking target commodity is found in the checking list 4025. In the drawings and the following description according to the second embodiment, the same elements as those in the first embodiment are denoted by the same reference numerals. Therefore, descriptions of the same elements may be omitted. FIGS. 1, 2, 4, 5, 8, and 9 used in the description of the first embodiment are common to the second embodiment, and thus the descriptions thereof will be omitted here.

FIG. 11 is a hardware block diagram illustrating the checkout machine 4 according to the second embodiment. The checkout machine 4 uses a part of the volatile memory region of the main memory 402 to store the checking list 4025. The checking list 4025 includes a region for the commodity sales data, an occupation allowed to sell, and checking information in the order of registration, for example. The commodity sales data includes a commodity code, a major classification code, a minor classification code, a commodity name, a price, a sales quantity, a sales amount, and the like of a purchased commodity. The occupation allowed to sell field indicates employee types allowed to sell items corresponding to the minor classification code included in the commodity sales data, based on the management data record 4024. The checking information is data for identifying whether the checking target commodity has been checked by a qualified attendant as required. The checking information is set to “1” when the checking target commodity has been checked by a qualified attendant. An initial state of the checking information is “0”. The checking list 4025 is not limited to the above items.

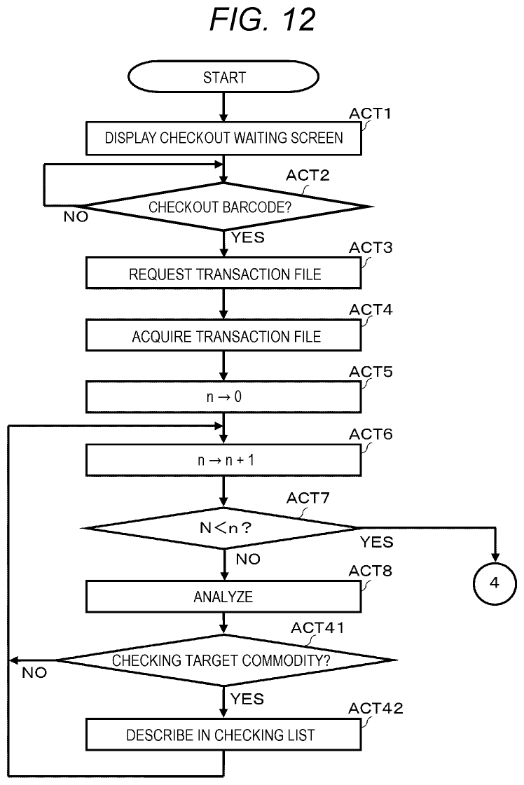

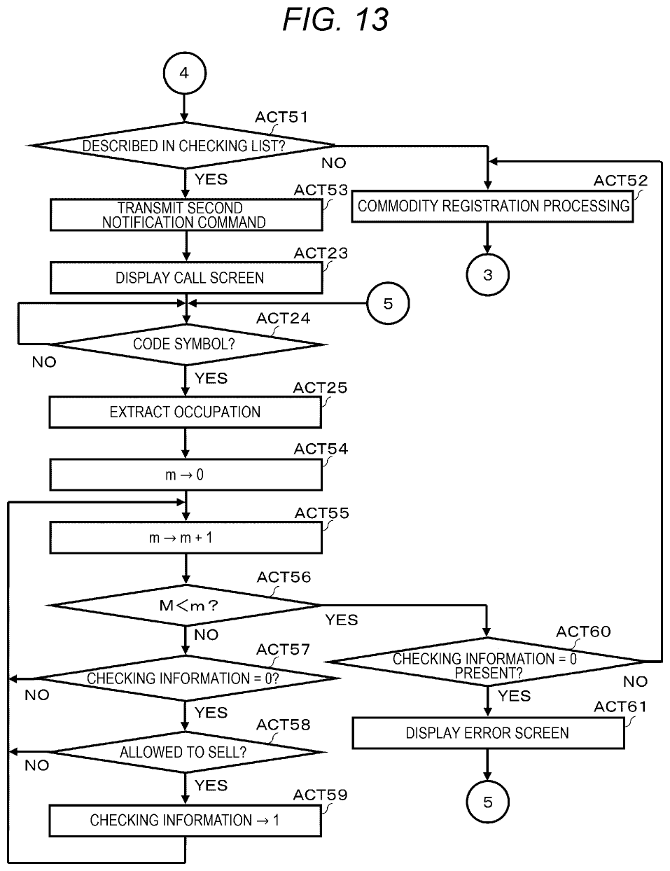

FIGS. 12 and 13 are flowcharts illustrating a procedure of information processing executed by the processor 401 according to a checkout program according to the second embodiment. Further, FIGS. 12 and 13 correspond to FIGS. 6 and 7 described in the first embodiment, respectively. Therefore, the same processing acts as those in the first embodiment are denoted by the same reference numerals. The operation described below is an example. The operation procedure and the step thereof are not particularly limited as long as similar results can be achieved.

In the second embodiment, as illustrated in FIG. 12, the processor 401 executes processing of ACT 1 to ACT 8 in the same manner as described above, and then executes processing of ACT 41 and ACT 42.

In ACT 41, the processor 401 checks, based on the management data record 4024 stored in the management database 4023, whether the minor classification code included in the commodity sales data indicates a checking target commodity.

If the minor classification code does not indicate a checking target commodity, the processor 401 determines NO in ACT 41 and proceeds to ACT 6.

If the minor classification code indicates a checking target commodity, the processor 401 determines YES in ACT 41, and proceeds to ACT 42. That is, the processor 401 detects, by the function of the detection unit 4012, a checking target commodity based on the commodity sales data.

In ACT 42, the processor 401 describes data related to the checking target commodity in the checking list 4025. Specifically, the processor 401 describes the commodity sales data of the checking target commodity in the checking list 4025. Based on the management data record 4024, the processor 401 extracts the occupation allowed to sell corresponding to the minor classification code included in the commodity sales data, and describes the occupation allowed to sell in the checking list 4025. The processor 401 sets the checking information to “0”. Then, the processor 401 returns to ACT 6. The processor 401 executes the processing of ACT 6 to ACT 8, ACT 41, and ACT 42 in the same manner as described above.

If a number counter n exceeds a maximum value N, that is, when analysis of the commodity sales data for all the series of numbers is completed, the processor 401 determines YES in ACT 7 and proceeds to ACT 51 in FIG. 13.

In ACT 51, the processor 401 checks whether data related to a checking target commodity is described in the checking list 4025. If the data related to at least one checking target commodity is described in the checking list 4025, the processor 401 determines that a checking target commodity is present. If no data related to even one checking target commodity is described in the checking list 4025, the processor 401 determines that no checking target commodity is present.

If no data related to even one checking target commodity is described in the checking list 4025, that is, if no checking target commodity is present, the processor 401 determines NO in ACT 51 and proceeds to ACT 52. In ACT 52, the processor 401 executes commodity registration processing of the first to N-th purchased commodities registered in a transaction file. Specifically, the processor 401 registers and processes sales data of the purchased commodities in a sales totalization memory, based on the commodity sales data analyzed in the processing of ACT 8 in FIG. 6. Through the registration processing, a total amount of the transaction is calculated. Then, the processing proceeds to ACT 31 in FIG. 8. The processor 401 executes the processing of ACT 31 to ACT 34 in the same manner as described above.

If data related to at least one checking target commodity is described in the checking list 4025, that is, if a checking target commodity is present, the processor 401 determines YES in ACT 51 and proceeds to ACT 53.

In ACT 53, the processor 401 issues a second notification command, and controls the communication interface 405 to transmit the second notification command to the attendant terminal 6, by a function of the output unit 4013. By this control, the second notification command is transmitted from the communication interface 405 to the attendant terminal 6 via the communication network 7. The second notification command includes the data of the checking list 4025.

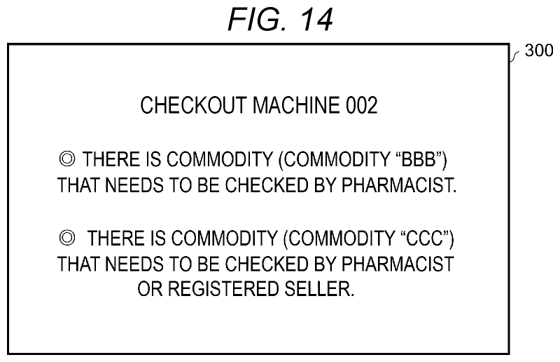

The attendant terminal 6 that has received the second notification command causes the touch panel to display a second notification screen 300 (see FIG. 14).

FIG. 14 is a schematic diagram illustrating an example of the second notification screen 300. As illustrated in FIG. 14, the second notification screen 300 includes a message for notifying an attendant that there are one or more commodities (i.e., checking target commodities) that need to be checked by an attendant on the checkout machine 4 identified according to the checkout machine ID. FIG. 14 illustrates a case in which there are a commodity “BBB” that needs to be checked by a pharmacist and a commodity “CCC” that needs to be checked by a pharmacist or a registered seller on the checkout machine 4 having the checkout machine ID of “002”. The text displayed in FIG. 14 is an example.

Return to the description of FIG. 13.

In the second embodiment, the processor 401 executes the processing of ACT 23 to ACT 25 in the same manner as described above, and then executes processing of ACT 54.

In ACT 54, the processor 401 initializes a number counter m to “0”. In ACT 55, the processor 401 counts up the number counter m by “1”. In ACT 56, the processor 401 checks whether the number counter m exceeds a maximum value M of a series of numbers in the checking list 4025.

If the number counter m is equal to or less than the maximum value M, the processor 401 determines NO in ACT 56 and proceeds to ACT 57. In ACT 57, the processor 401 confirms whether m-th checking information in the checking list 4025 is set to “0”.

If the m-th checking information in the checking list 4025 is not set to “0”, that is, if the checking information is set to “1”, the processor 401 determines NO in ACT 57 and returns to ACT 55. A case in which the checking information is set to “1” means a case in which the checking target commodity was already checked by a qualified attendant.

If the m-th checking information in the checking list 4025 is set to “0”, the processor 401 determines YES in ACT 57 and proceeds to ACT 58.

In ACT 58, the processor 401 checks, by a function of the authentication unit 4014, whether the occupation extracted in the processing of ACT 25 is included in the occupation allowed to sell corresponding to the m-th checking information in the checking list 4025.

If the occupation extracted in the processing of ACT 25 is not included in the occupation allowed to sell corresponding to the m-th checking information, the processor 401 determines NO in ACT 58 and returns to ACT 55.

If the occupation extracted in the processing of ACT 25 is included in the occupation allowed to sell corresponding to the m-th checking information, the processor 401 determines YES in ACT 58 and proceeds to ACT 59.

In ACT 59, the processor 401 determines that the checking target commodity was checked by a qualified attendant, and sets the m-th checking information in the checking list 4025 to “1”. Then, the processor 401 returns to ACT 55. The processor 401 executes the processing of ACT 55 to ACT 59 in the same manner as described above.

If the number counter m exceeds the maximum value M, that is, if checking of the checking list 4025 for all the registered items is completed, the processor 401 determines YES in ACT 56 and proceeds to ACT 60. In ACT 60, the processor 401 checks whether checking information set to “0” is present in the checking list 4025.

If the checking information set to “0” is present, the processor 401 determines YES in ACT 60 and proceeds to ACT 61. A case in which the checking information set to “0” is present means a case in which an attendant ID stored in a code symbol read by the scanner 407 corresponds to an occupation that is not allowed to sell for at least one checking target commodity.

In ACT 61, the processor 401 causes the touch panel 408 to display an error screen. For example, in a case in which there are a plurality of checking target commodities, the error screen may further include a notification that there is a checking target commodity checked by a qualified attendant and that there is another checking target commodity not checked because the attendant ID is not allowed to sell the checking target commodity. Then, the processor 401 returns to ACT 24. That is, the processor 401 waits for the code symbol in which the attendant ID is stored to be read by the scanner 407.

If no checking information set to “0” is present, the processor 401 determines NO in ACT 60 and returns to ACT 52. That is, the processor 401 determines that all of the one or more checking target commodities were checked by the qualified attendant, and executes, by a function of the control unit 4015, the commodity registration processing of the first to the N-th checking target commodities registered in the transaction file. Then, the processing proceeds to ACT 31 in FIG. 8. The processor 401 executes the processing of ACT 31 to ACT 34 in the same manner as described above. As described above, the processor 401 ends the information processing of the procedure illustrated in the flowcharts in FIGS. 8, 12, and 13.

As described above, in the second embodiment, if a minor classification code included in the commodity sales data registered in the transaction file indicates a checking target commodity, the processor 401 describes data related to the checking target commodity in the checking list 4025. The second notification command is transmitted to the attendant terminal 6 when the analysis of the commodity sales data for all the registered items is completed and the data related to at least one checking target commodity is in the checking list 4025. Accordingly, the second notification screen 300 is displayed on the touch panel of the attendant terminal 6. Therefore, when there are a plurality of checking target commodities, the attendant is collectively notified that there are a plurality of checking target commodities. Therefore, the attendant does not need to rush to the checkout machine 4 which is a notification target for each checking target commodity, which reduces labor and burden.

When the attendant causes the scanner 407 to read the code symbol in which the attendant ID is stored, the processor 401 extracts the occupation corresponding to the attendant ID, based on the attendant data record 4022 stored in the attendant database 4021. If a plurality of pieces of data related to the checking target commodity are described in the checking list 4025, whether the occupation corresponding to the attendant ID is included in the occupation allowed to sell in the checking list 4025 is checked for each piece of the data. If the occupation corresponding to the attendant ID is included in the occupation allowed to sell in the checking list 4025, the processor 401 sets the checking information to “1”. Then, when the checking of the checking list 4025 for all the registered items is completed and there is no checking information set to “0” in the checking list 4025, the processor 401 determines that all the plurality of checking target commodities were checked by the qualified attendant, and executes the commodity registration processing of the first to the N-th purchased commodities in the transaction file. Therefore, even if there are a plurality of checking target commodities, only by causing the scanner 407 to read the code symbol in which the qualified attendant ID is stored, the checking target commodities can be collectively registered, which is efficient.

Although a first embodiment and a second embodiment have been described above, the present disclosure are not limited thereto.

The above embodiments exemplify a case in which a customer use their own smartphone as the shopping supporting terminal 1 which may be set on a shopping cart or carried by hand. In other examples, a tablet terminal set up as a so-called “cart terminal” that is attached to a shopping cart by the store or the like may be used as the shopping supporting terminal 1.

In certain embodiments, a checkout barcode is obtained by encoding, by a predetermined barcode system, the terminal identification information of the shopping supporting terminal 1. The checkout barcode is not limited thereto. The checkout barcode may be a code unique to a transaction file.

In certain embodiments, the checkout machine 4 stores the attendant database 4021 and the management database 4023 in the volatile memory region of the main memory 402. In other examples, the attendant database 4021 and the management database 4023 may be stored in the auxiliary storage device 403 or an external storage device connected to the checkout machine 4.

In certain embodiments, when a checkout barcode is read by the scanner 407, the processor 401 acquires the transaction file associated with the checkout barcode from the virtual POS server 3. However, the method for acquiring the transaction file is not limited thereto. For example, a checkout machine code including a barcode or a two-dimensional code system can be prepared in the vicinity of the checkout machine 4. The checkout machine code can be obtained by encoding the checkout machine ID set in the checkout machine 4. A customer who completed the shopping and moved to the front of the checkout machine 4 causes the camera of the shopping supporting terminal 1 to read the checkout machine code. Then, the terminal identification information and the checkout machine code are transmitted from the shopping supporting terminal 1 to the virtual POS server 3. The virtual POS server 3 transmits the transaction file associated with the terminal identification information to the checkout machine 4 identified according to the checkout machine code. Thus, the processor 401 can acquire the transaction file.

In certain embodiments, the processor 401 analyzes commodity sales data registered in a transaction file for each individual piece of commodity sales data in the order of the registration of the items. In some examples, if a price included in the commodity sales data is missing for some reason, the processor 401 may request data of the price associated with the commodity code included in the commodity sales data from the store server 2. The store server 2 that has received the request may extract the data of the price from the commodity record associated with the commodity code and transmit the data of the price to the checkout machine 4. Missing data that may be remedied in this manner or the like is not limited to a price.

In certain embodiments the processor 401 causes the touch panel 408 to display the call screen 100. In other examples, whether there is a commodity that needs to be checked by an attendant and whether an attendant is called may be output by automated voice message or the like.

In certain embodiments, the call screen 100 includes a message for notifying a customer that there is a commodity that needs to be checked by an attendant and that an attendant is automatically called. In other examples, the call screen 100 may just notify a customer of a commodity that needs to be checked by an attendant. A specific notification may be, for example, “there is a commodity ‘DDD’ that needs to be checked by a pharmacist”.

In certain embodiments, the attendant terminal 6 causes the touch panel to display the first notification screen 200. In other examples, whether there is a commodity that needs to be checked by the attendant may be indicated by output of an automated voice message or the like from the checkout machine 4 identified according to the checkout machine ID.

In certain embodiments, a checking target commodity is any one of a first-category medicinal product, a second-category medicinal product, or a third-category medicinal product. In other examples, a checking target commodity may instead, or in addition, be a commodity whose sale is controlled by age restrictions such as an alcoholic beverage or a cigarette. In such a case, checking generally needs only to be performed by a store clerk.

In certain embodiments, the checking list 4025 is stored in a part of the volatile memory region of the main memory 402. In other examples, the checking list 4025 may be stored in the auxiliary storage device 403. In such a case, the auxiliary storage device 403 is a storage unit that stores the target commodity detected by the detection unit 4012.

In the second embodiment, if there is more than one checking target commodity, the processor 401 executes, by the function of the control unit 4015, the commodity registration processing on the first to the N-th purchased commodities registered in the transaction file after all the checking target commodities have been appropriately checked by a qualified attendant. That is, after all the checking target commodities are checked by a qualified attendant, the processor 401 executes the commodity registration processing of all the purchased commodities including the checking target commodities. In other examples, a checking target commodity and a regular purchased commodity (that is, not a checking target commodity) may be handled at different times in the commodity registration processing.

For a regular purchased commodity (not a checking target commodity), the processor 401 may execute the commodity registration processing after determining NO in ACT 41, for example. Then, the processor 401 may return to ACT 6.

When the commodity registration processing on the regular purchased commodity is executed in such a manner, the processor 401 may later execute the commodity registration processing for the checking target commodity after approval.

For example, after determining NO in ACT 60, the processor 401 may execute the commodity registration processing on one or more checking target commodities in ACT 52. Then, the processor 401 may proceed to ACT 31 in FIG. 8.

The processor 401 may execute the commodity registration processing on the checking target commodity after ACT 59, for example. In such a case, after determining NO in ACT 60, the processor 401 may proceed to ACT 31 in FIG. 8.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A checkout apparatus for a point of sales (POS) system, the checkout apparatus comprising:
a network interface;
a scanner; and
a processor configured to:
upon receipt of a checkout code via the scanner, acquire data of one or more commodities that have been registered for purchase by a customer terminal,
determine whether said one or more commodities include a particular type of commodity that needs to be checked by an attendant, and
upon determining that said one or more commodities include the particular type of commodity, control the network interface to transmit a notification to an attendant terminal before executing checkout processing on the commodity.

2. The checkout apparatus according to claim 1, further comprising:
a display, wherein
the processor is further configured to, upon determining that said one or more commodities include the particular type of commodity, control the display to display a first screen indicating that there is a commodity that needs to be checked by an attendant.

3. The checkout apparatus according to claim 2, wherein the first screen indicates a name of the particular type of commodity and an occupation of an attendant qualified to check the commodity.

4. The checkout apparatus according to claim 1, wherein the processor is further configured to, after the notification is transmitted to the attendant terminal:
upon receipt of an attendant ID via the scanner, determine whether an attendant having the attendant ID is qualified to check the particular type of commodity, and
upon determining that the attendant is qualified, execute the checkout processing on the particular type of commodity.

5. The checkout apparatus according to claim 1, wherein the notification indicates identification information of the checkout apparatus, an occupation of an attendant qualified to check the particular type of commodity, and a name of the commodity.

6. The checkout apparatus according to claim 1, further comprising:
a display, wherein
the processor is further configured to, upon determining that said one or more commodities do not include the particular type of commodity, control the display to display a second screen through which a payment method can be selected.

7. The checkout apparatus according to claim 1, further comprising:
an interface connectable to an automatic change machine, wherein
the processor is further configured to execute the checkout processing based on cash that has been paid via the automatic change machine.

8. The checkout apparatus according to claim 1, further comprising:
a printer, wherein
the processor is further configured to control the printer to print a receipt during the checkout processing.

9. The checkout apparatus according to claim 1, wherein the scanner reads the checkout code displayed on the customer terminal.

10. The checkout apparatus according to claim 9, wherein the checkout code is a two-dimensional code generated by encoding identification information of the customer terminal.

11. A method performed by a checkout apparatus in a point of sales (POS) system, the method comprising:
upon receipt of a checkout code via a scanner, acquiring data of one or more commodities that have been registered for purchase by a customer terminal;
determining whether said one or more commodities include a particular type of commodity that needs to be checked by an attendant; and
upon determining that said one or more commodities include the particular type of commodity, transmitting a notification to an attendant terminal before executing checkout processing on the commodity.

12. The method according to claim 11, further comprising:
upon determining that said one or more commodities include the particular type of commodity, displaying a first screen indicating that there is a commodity that needs to be checked by an attendant.

13. The method according to claim 12, wherein the first screen indicates a name of the particular type of commodity and an occupation of an attendant qualified to check the commodity.

14. The method according to claim 11, further comprising:
after the notification is transmitted to the attendant terminal,
upon receipt of an attendant ID via the scanner, determining whether an attendant having the attendant ID is qualified to check the particular type of commodity, and
upon determining that the attendant is qualified, executing the checkout processing on the particular type of commodity.

15. The method according to claim 11, wherein the notification indicates identification information of the checkout apparatus, an occupation of an attendant qualified to check the particular type of commodity, and a name of the commodity.

16. The method according to claim 11, further comprising:
upon determining that said one or more commodities do not include the particular type of commodity, displaying a second screen through which a payment method can be selected.

17. The method according to claim 11, further comprising:
executing the checkout processing based on cash that has been paid via an automatic change machine connected to the checkout apparatus.

18. The method according to claim 11, further comprising:
printing a receipt via a printer during the checkout processing.

19. The method according to claim 11, wherein the checkout code is read from the customer terminal displaying the checkout code thereon.

20. A point of sales (POS) system for a retail store, the system comprising:
an attendant terminal to be operated by an attendant; and
a checkout apparatus including:
a network interface,
a scanner, and
a processor configured to:
upon receipt of a checkout code f via the scanner, acquire data of one or more commodities that have been registered for purchase by a customer terminal,
determine whether said one or more commodities include a particular type of commodity that needs to be checked by the attendant, and
upon determining that said one or more commodities include the particular type of commodity, control the network interface to transmit a notification to the attendant terminal before executing checkout processing on the commodity.
